(19) United States
(12) Patent Application Publication
(10) Pub. No.: US 2024/0028828 A1
(43) Pub. Date: Jan. 25, 2024

(54) MACHINE LEARNING MODEL ARCHITECTURE AND USER INTERFACE TO INDICATE IMPACT OF TEXT NGRAMS

(71) Applicant: DataRobot, Inc., Boston, MA (US)

(72) Inventors: Anton Kasyanov, Kyiv (UA); Jonathan Chang, Austin, TX (US); Mykyta Yarmak, Kyiv (UA); Ee Kin Chin, Singapore (SG)

(73) Assignee: DataRobot, Inc., Boston, MA (US)

(21) Appl. No.: 18/225,342

(22) Filed: Jul. 24, 2023

Related U.S. Application Data
(60) Provisional application No. 63/391,925, filed on Jul. 25, 2022.

(51) Int. Cl. G06F 40/284

(52) U.S. Cl. CPC G06F 40/284

(57) ABSTRACT

Aspects of this technical solution can identify a plurality of n-grams at a plurality of locations in a first data set comprising text, generate, via a model trained with machine learning, a first prediction for the first data set, generate, via the model, a second prediction for a second data set that lacks the first n-gram at a first location of the plurality of locations, generate, by comparing a first prediction for the first data set with a second prediction for the second data set, an impact of the first n-gram at the first location, and cause a user interface to present at least a portion of the first data set with a visual indication corresponding to the impact, the visual indication applied to a portion of the user interface corresponding to the first n-gram and positioned in the user interface at the first location.

### CROSS-REFERENCE TO RELATED PATENT APPLICATIONS

This application claims the benefit of priority under 35 U.S.C. § 119 to U.S. Provisional Patent Application Ser. No. 63/391,925, entitled “ MACHINE LEARNING MODEL INTERPRETATION OF TEXT NGRAMS,” filed Jul. 25, 2022, the contents of all such applications being hereby incorporated by reference in its their entirety and for all purposes as if completely and fully set forth herein.

### TECHNICAL FIELD

This disclosure relates to but is not limited to a machine learning model architecture and user interface to indicate impact of text n-grams.

### BACKGROUND

A machine learning system can train models based on training datasets. The machine learning system can implement training techniques that determine values for various parameters or weights of the models. The models can execute on data sets to make decisions, predictions, other inferences based on various features in the data set.

### SUMMARY

This technical solution is directed to a machine learning model interpretation of text n-grams. The technical solution can generate an explanation based on text n-grams for any machine learning model. For example, a model trained used machine learning can be applied or used to make a prediction on or about a data set that includes text. However, when making the prediction, it may be challenging to debug, determine, validate, or otherwise evaluate whether the model has erred in making a prediction or what the cause or source of the error may have been. This technical solution can facilitate detecting such errors and otherwise evaluating the performance of a model to facilitate improve the performance and deployment of machine learning models in various fields of technology or technical use cases.

At least one aspect is directed to a system. The system can include a data processing system can include one or more processors and memory. The system can identify a plurality of n-grams at a plurality of locations in a first data set can include text. The system can generate, via a model trained with machine learning, a first prediction for the first data set. The system can generate, via the model, a second prediction for a second data set that lacks the first n-gram at a first location of the plurality of locations. The system can generate, by comparing a first prediction for the first data set with a second prediction for the second data set, an impact of the first n-gram at the first location. The system can cause a user interface to present at least a portion of the first data set with a visual indication corresponding to the impact, the visual indication applied to a portion of the user interface corresponding to the first n-gram and positioned in the user interface at the first location.

At least one aspect is directed to a method. The method can include receiving, by a data processing system, via a user interface and in communication with a client device, a data set can include text. The method can include identifying, by a data processing system can include one or more processors and memory, a plurality of n-grams at a plurality of locations in a first data set. The method can include removing, by the data processing system, a first n-gram of the plurality of n-grams from a first location of the plurality of locations to generate a second data set that lacks the first n-gram at the first location. The method can include generating, by the data processing system, via a model trained with machine learning, a first prediction for the first data set. The method can include generating, by the data processing system via the model, a second prediction for a second data set that lacks the first n-gram at a first location of the plurality of locations. The method can include generating, by the data processing system comparing a first prediction for the first data set with a second prediction for the second data set, an impact of the first n-gram at the first location. The method can include causing by the data processing system, a user interface to present at least a portion of the first data set with a visual indication corresponding to the impact, the visual indication applied to a portion of the user interface corresponding to the first n-gram and positioned in the user interface at the first location.

At least one aspect is directed to a non-transitory computer readable medium storing instructions that, when executed by one or more processors, cause the one or more processors. The processor can identify a plurality of n-grams at a plurality of locations in a first data set can include text. The processor can generate, via a model trained with machine learning, a first prediction for the first data set. The processor can generate, via the model, a second prediction for the second data set that lacks the first n-gram at a first location of the plurality of locations. The processor can generate, by a comparison of a first prediction for the first data set with a second prediction for the second data set, an impact of the first n-gram at the first location. The processor can cause a user interface to present at least a portion of the first data set with a visual indication corresponding to the impact, the visual indication applied to the first n-gram and positioned in the user interface at the first location.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a block diagram of an example system for machine learning model interpretations of text n-grams.

FIGS. 2-10 are examples of graphical user interfaces for machine learning model interpretations of text n-grams.

FIG. 11 depicts an example method in accordance with present implementations.

FIG. 12 depicts an example computing architecture that can be used to implement the system depicted in FIG. 1, the graphical user interfaces depicted in FIGS. 2-10, or the method depicted in FIG. 11.

FIG. 13 depicts an example method in accordance with present implementations.

FIG. 14 depicts an example method in accordance with present implementations.

FIG. 15 depicts an example method in accordance with present implementations.

### DETAILED DESCRIPTION

Following below are more detailed descriptions of various concepts related to, and implementations of, methods, apparatuses, and systems of machine learning model interpretations of text n-grams. The various concepts introduced above and discussed in greater detail below may be implemented in any of numerous ways.

This technical solution is directed to a machine learning model interpretation of text n-grams. The technical solution can generate an explanation based on text n-grams for any machine learning model.

For example, a model trained used machine learning can be applied or used to make a prediction on or about a data set that includes text. However, when making the prediction, it may be challenging to debug, determine, validate, or otherwise evaluate whether the model has erred in making a prediction or what the cause or source of the error may have been. For example, it can be challenging to understand how text-based machine learning models arrive at or generate predictions. It may be insufficient to just understand the overall impact that a text feature has on the model's predictions. This technical solution can provide an interpretation or understanding of how the words in the text feature influence the predictions in order to validate and understand the model and the importance the model places on words. For example, in a situation where a model is used on resumes to predict candidate viability, this technical solution can provide an indication as to exactly which keywords are positively and negatively impacting the model's judgment of the candidate (whether that is a specific skill, a particular university, or a degree, etc.).

Text and human language can be complex, fluid, and inconsistent with contextual nuances, ambiguity, and many more complications involved in understanding text. As such, it can be challenging to determine how a machine learning model interprets or uses text to make a prediction, and without making this determination, it may not be possible to effectively validate the model or the importance (both negative and positive impacts) the model places on words or understanding a model's shortcomings when dealing with specific words in the broader context. Without surfacing this level of granularity in highlighting the importance of each word, it can be excessively time and resource intensive to validate a model or interpret how the model makes a prediction, thereby detracting from technical efficiencies brought about by using a machine learning model, or resulting in deployment of an inaccurate, faulty, or otherwise unreliable model. Deploying an inaccurate, faulty or unreliable model in a real-time use case can result in technical problems or errors in another technical field or process in which a text-based machine learning model is deployed to perform an operation or function (e.g., resume classification, software technical support, transaction processing, electronic message routing, or manufacturing processes).

This technical solution can highlight at a word, phrase, or general n-gram level the text and how it influences the model. Providing an indication at the general n-gram level increases the level of granularity or resolution with which the model can be interpreted relative to just highlighting a text feature as an important feature that drives a model's predictions. Thus, this technical solution can provide the computing infrastructure and user interface design to compute, retrieve and display the n-gram based text explanations for any machine learning model that takes text as an input. By doing so, this technical solution can facilitate detecting such errors and otherwise evaluating the performance of a model to facilitate improve the performance and deployment of machine learning models in various fields of technology or technical use cases. The technical solution can provide a design used to display text n-gram explanations that can easily and reliably display the explanations via an improved graphical user interface for analyses during the machine learning model building process, for example. The graphical user interface can display the raw text that was used to make predictions, and provide an indication of the impact and polarity of the impact (e.g., negative or positive) the n-gram has on the prediction.

Thus, this technical solution achieves at least a technical improvement to provide accurate quantitative indications of impact of parts of speech with respect to particular data domains, at a scale, latency and accuracy not achievable by manual processes. This technical solution achieves at least a technical improvement to general and present quantitative metrics corresponding to components of natural language, including but not limited to n-grams, by a user interface arranged to provide a large number of discrete and interdependent quantitative metrics with data granularity and density not achievable by manual processes. For example, the particular arrangements of the user interface as discussed herein provide at least the technical improvement noted herein, but are not limited thereto.

In an illustrative example, the model can be used on resumes to predict candidate viability. With this technical solution, a system can indicate exactly which n-grams or keywords are positively and negatively impacting the model's judgment of the candidate (e.g. a specific skill, a particular university, or a degree, etc.).

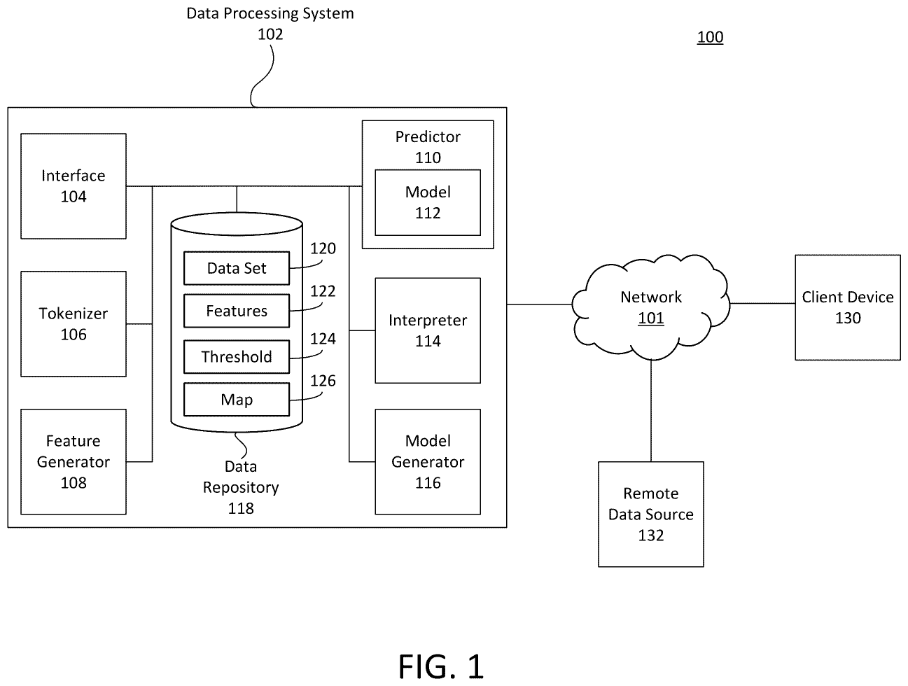

FIG. 1 is a block diagram of an example system 100 for machine learning model interpretations of text n-grams. The system 100 can include a data processing system 102. The data processing system 102 can be a server system, a cloud computing platform, a local computing system, a laptop computer, a desktop computer. The data processing system 102 can interact or communicate with a client device 130 via a network 101. The network 101 can include computer networks such as the Internet, local, wide, metro, or other area networks, intranets, cellular networks, satellite networks, and other communication networks such as voice or data mobile telephone networks. The client device 130 can be a computing system separate from the data processing system 102. The client device 130 can be integrated with the data processing system 102. For example, the data processing system 102 can be a component of the client device 130 or the client device 130 can be a component of the data processing system 102.

The client device 130 can be a server system, a cloud computing platform, a local computing system, a laptop computer, a desktop computer. The client device 130 can be a device of a user, for example, a machine learning engineer, a data scientist, a business manager, or any other user. The user can provide a data set to the data processing system 102 through the client device 130. For example, the user can upload the data set 120 to the data processing system 102 via the client device 130. The data set 120 can be uploaded via at least one network 101.

The data processing system 102 can include at least one interface 104 to communicate with or interact with one or more of the client device 130 or remote data source via network 102. The remote data source 132 can refer to or include any data source containing data, text files, data sets, or information that facilitates generating predictions or interpreting machine learning model predictions. The data processing system 102 can include at least one tokenizer 106 to identify n-grams or keywords in a data set. The data processing system 102 can include at least one feature generator 108 to generate features from the data set. The data processing system 102 can include at least one predictor 110 to generate a prediction or inference using a model 112 (e.g., a text-based model trained using machine learning). The data processing system 102 can include at least one interpreter 114 to determine how an n-gram impacted a prediction made by the predictor 110, and provide an indication of how the n-gram impacted the prediction. The data processing system 102 can include at least one model generator 116 to generate or a train a model using machine learning with a training data set. The data processing system 102 can include or access a data repository 118 storing a data set 120, features 122, a threshold 124, or a map 126. The data repository 112 can include one or more local or distributed databases, and can include a database management system.

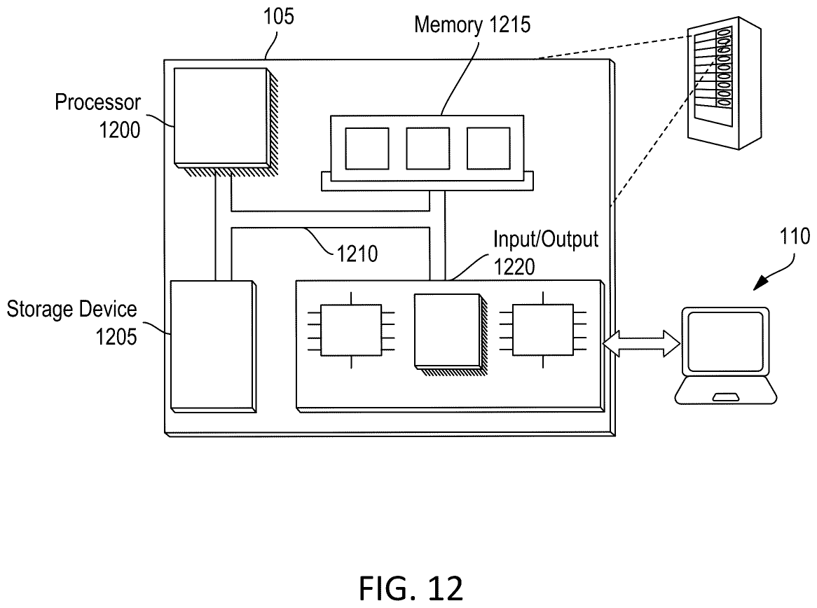

The interface 104, tokenizer 106, feature generator 108, predictor 110, interpreter 114, or model generator 116 can each include at least one processing unit or other logic device such as a programmable logic array engine, or a module configured to communicate with the data repository 118 or database. The interface 104, tokenizer 106, feature generator 108, predictor 110, interpreter 114, or model generator 116 can be separate components, a single component, or part of the data processing system 102. The data processing system 102 can include hardware elements, such as one or more processors, logic devices, or circuits. For example, the data processing system 102 can include one or more components, structures of functionality of the computing device depicted in FIG. 12.

The interface 104 can provide a graphical user interface or other user interface accessible by the client device 130. The interface 104 can include or provide input or output via one or more input or output devices depicted in FIG. 12, including, for example, a keyboard, mouse, display device, or touch screen. The data processing system 102 can receive, via interface 104, a data set 120 from client device 130.

The data set 120 can be in a file of a particular file format. The file can be a comma separated value (CVS) file, a tab separated value (TSV) file, a data source view (DSV) file, an EXCEL spreadsheet (XLS) file, an EXCEL Open Extensible Markup Language (XML) Spreadsheet (XLSX) file, a Statistical Analysis System 7BDAT (SAS7BDAT) file, a geographic JavaScript Object Notation (GEOJSON) file, a GNU zipped (GZ) file, a BZ1 file, a tape achieve file (TAR) file, a TGZ file, or a zipped (ZIP) file. The data set 120 can include data in one or modalities, including, for example, text, numeric values, or images. The data set 120 can include or be processed to generate features. Features can be text features or other types of features. Features can be individual measurable properties that a machine learning model can train on or generate inferences or predictions on. The features can include categorical features, numerical features, text features, location features, Boolean features, or any other type of feature.

The data processing system 102 can include a tokenizer 106 designed, constructed and operational to identify n-grams at locations in the data set 120. An n-gram can refer to or include a word in the text. The n-gram can refer to or include multiple contiguous words in the text. The n-gram can be referred to or include a keyword. The tokenizer 106 can be configured with or include a tokenization technique to identify the n-grams in the data set 120. Example tokenization techniques can include a deep learning tokenizer, a treebank tokenizer, or linguistic rules.

The tokenizer 106 can pre-process the data set to select a tokenization technique. For example, the tokenizer 106 can evaluate the data set to determine a language of the text, and then select linguistic rules for the determined language to use to identify n-grams in the text. In some case, the tokenizer 106 can execute a .split( )function to separate the text into tokens based on space separation. In some cases, the tokenizer 106 can utilize a deep learning tokenizer such as a natural language processing technique or toolkit to identify n-grams in the data set. In some cases the tokenizer 106 can use a treebank tokenizer that uses regular expressions to tokenize the data set.

The tokenizer 106 can be configured with any technique or function that can use language data for a text column identified during an exploratory data analysis (e.g., pre-processing) to choose or select an appropriate text tokenization technique. The tokenizer 106, using the selected tokenization technique, can split the text data set into relatable n-grams. The data processing system 102 can further process the relatable n-grams to obtain an impact score for the relatable n-gram relative to a baseline score.

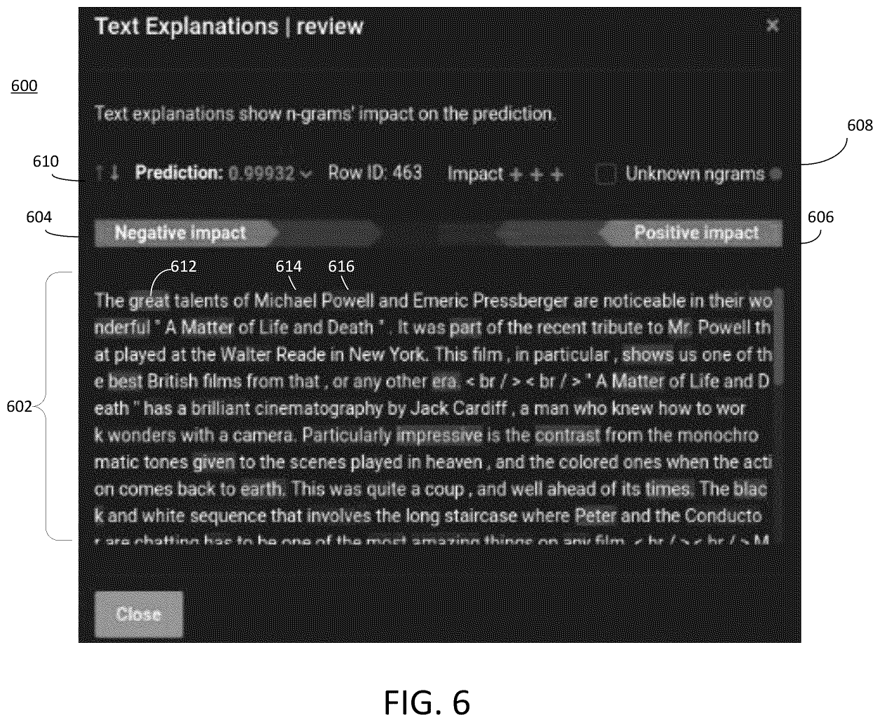

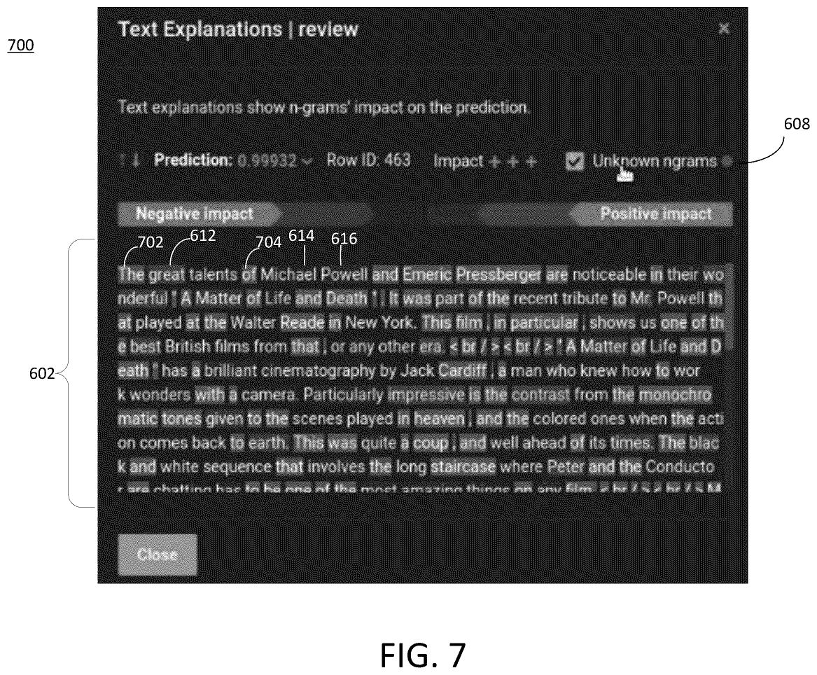

For example, using the tokenization technique, the tokenizer 106 can identify each keyword or n-gram in the data set 120 or text. FIGS. 6 and 7 illustrate example n-grams identified in a data set that includes text. For example, the tokenizer 106 can identify the n-gram and a location for the n-gram in the data set. The location can refer to which entry in the data set the n-gram is in, or indicate a relationship of the n-gram with respect to the words before and after the n-gram. For example, as depicted in FIG. 7, the n-gram “great”, which is highlighted, appears after the first word “The” and before the third word “talents”.

The data processing system 102 can store the tokens or n-grams in data repository 118. The data processing system 102 can store or maintain, in data repository 118, the location for each of the n-grams identified by the tokenizer 106 for further processing by the data processing system 102.

The data processing system 102 can include a feature generator 108 designed, constructed and operational to generate one or more features from the data set or text in the data set. The data processing system 102 can generate the features using any feature generation or feature engineering technique. Features can be based on a block of text in the data set. Features can be based on or include a representation of a word, phrase, keyword, or n-gram in the data set. Features can be different from the n-gram or can include one or more n-grams. Text features can be broader than an n-gram identified by the tokenizer 106. For example, the feature generator 108 can utilize a text vectorization technique to generate or identify text features from the data set. The feature generator 108 can convert the text in the data set to vectors, arrays or tensors, for example, which can input into a model 112.

In some cases, the feature generator 108 can utilize one hot encoding to encode categorical features, where each value for a feature can be mapped to a new column. The feature generator 108 can use feature engineering techniques such as bag of words model, term frequency, inverse document frequency, or word embeddings, for example.

The feature generator 108 can generate features from the data set 120 received from the client device 130. The feature generator 108 can generate two sets of features or data sets. The feature generator 108 can generate a feature for the data set based at least in part on the first n-gram at the first location. For example, to determine the impact or importance of a particular n-gram on the prediction output by the model 112 of the predictor 110, the feature generator 108 can generate a baseline or first feature set based on the full data set and n-grams. The feature generator 108 can generate a second data set by removing a first n-gram from original data set. The feature generator 108 can generate a second feature set or a second data set without using the first n-gram. For example, the feature generator 108 can generate a second data set that lacks the first n-gram at the first location by removing (or not including or omitting) the n-gram from the location. The feature generator 108 can then extract a second feature set from the second data set. The second feature set can be different from the first, baseline feature set because it does not include the first n-gram at the first location. The data processing system 102 can generate the baseline data set and feature set, and generate multiple additional data sets and feature sets that iteratively remove an n-gram.

The feature generator 108 can use one or more techniques to determine which n-grams to remove or to group together for removal. The feature generator 108 can leverage the tokenizer 106 to determine which n-grams to remove for a particular iteration. The tokenizer 108 can remove n-grams that are contextually related to one another. For example, the tokenizer 108 can treat the phrase “not no” as a single n-gram, as opposed to two different n-grams “not” and “no”. Thus, the data processing system 102 can detect which n-gram or group of n-grams to remove. In some cases, the tokenizer 106 can determine that the n-gram is “not no”, and the feature generator 108 can receive an indication to remove or include “not no” as a single n-gram.

The feature generator 108 can generate features that leverage an n-gram. In some cases, an n-gram may not be leveraged or extracted to generate any features. If an n-gram is not used by the feature generator 108 to generate a feature, or not used by the predictor 110 to generate a prediction, then the data processing system 102 can determine that the n-gram is unknown to the feature generator 108 and predictor 110. The feature generator 108 can provide an indication to the interpreter 114 to apply a visual indication to the unknown n-gram to indicate that the n-gram is not known or not used by the predictor 110 to make a prediction.

The data processing system 102 can include a predictor 110 designed, constructed and operational to make a prediction based on the feature set using a model 112 trained using machine learning. The model 112 can be trained or generated by the model generator 116. For example, the data processing system 102 can include a model generator 116 designed, constructed and operational to train a model using machine learning. The model generator 116 can train the model using any text-based machine learning technique, including, for example, naïve Bayes, support vector machines, deep learning, regression techniques, random forest, or k-means squared. The predictor 110 can generate a prediction or output from the model 110. In some cases, the predictor 110 can include a classifier to generate the prediction or output.

The predictor 110 can determine, via the model 112 trained with machine learning, a first prediction for the data set. The first prediction can be referred to as a baseline prediction as it may be based on the features extracted from the full data set that includes all of the n-grams. the predictor 110 can determine, via the model 112, a second prediction for the second data set. The second prediction can be for the second feature set which can be extracted from the second data set that lacks the first n-gram. The second prediction can be different from the first prediction.

The data processing system 102 can compare the first prediction with the second prediction to determine an impact from the first n-gram at the first location. For example, the second prediction can have a score, probability, confidence value, likelihood, coefficient, or other value that is higher or lower than the first prediction. If the second prediction is less than the first prediction, then the interpreter 114 may determine that the first n-gram had a positive impact on the prediction because the prediction using the first n-gram was higher. If the first prediction is less than the second prediction, then the interpreter may determine that the first n-gram had a negative impact on the prediction, because the prediction was higher when the first n-gram was not used.

The interpreter 114 can select a visual indication to represent the impact. The data processing system 102 can use a threshold 124 to determine whether the impact is negative or positive. The threshold 124 can be used to select a color map for the visual indication. The data processing system 102 can select the visual indication using a map 126. The map 126 can include a color map, font size map, font map, symbol map, grayscale map, or other map that can be used to represent negative and positive impact or a degree of negative and positive impact. The data processing system 102 can apply the visual indication to the first n-gram comprising a color selected from a color map that highlights the first n-gram in the user interface.

The interpreter 114 can provide, to the client device 130, instructions to cause the client device to present, via a user interface, at least a portion of the data set with the visual indication applied to the first n-gram at the first location. For example, FIGS. 6-7 depict illustrations of a graphical user interface that presents a portion of the data set with the visual indication applied to n-grams identified by the tokenizer 106. For example, the data processing system 102 can determine that a second n-gram of the plurality of n-grams is not used to generate a feature for input into the model to make the first prediction. The data processing system 102 can select, based on the map, a second visual indication different from the visual indication for the second n-gram. The data processing system 102 can provide, to the client device, instructions to cause the client device to present, via the user interface, at least the portion of the data set with the second visual indication applied to the second n-gram.

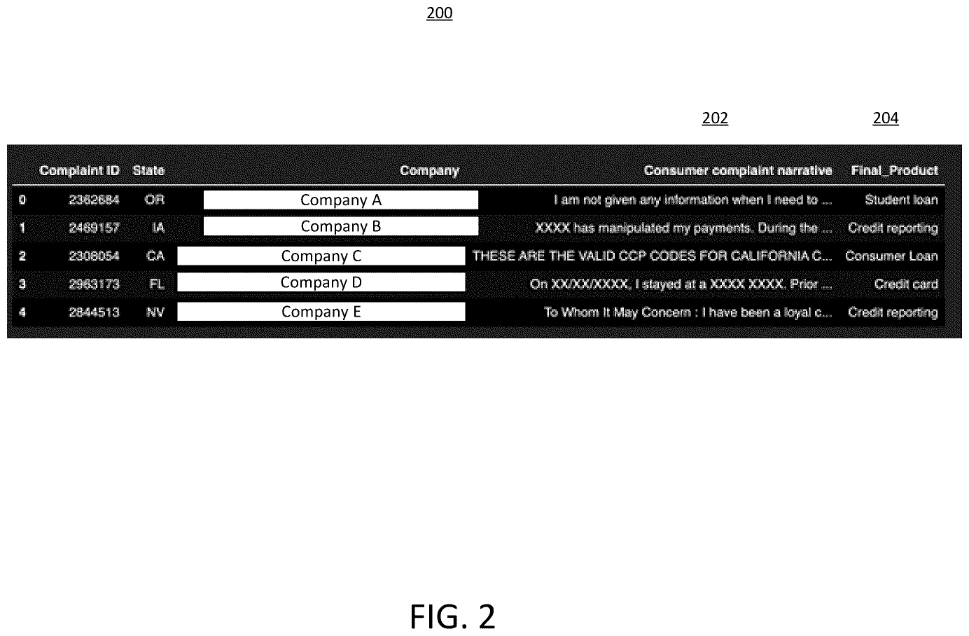

FIG. 2 is an example graphical user interface 200 depicting a data set (e.g., text in complaint 202) used by the data processing system 102 to generate a prediction. In the example in FIG. 2, the data processing system 102 can predict a which product the user is complaining about based on the text 202 of the consumer complaint. The “final product” 204 column depicts the prediction of the product based on the narrative 202.

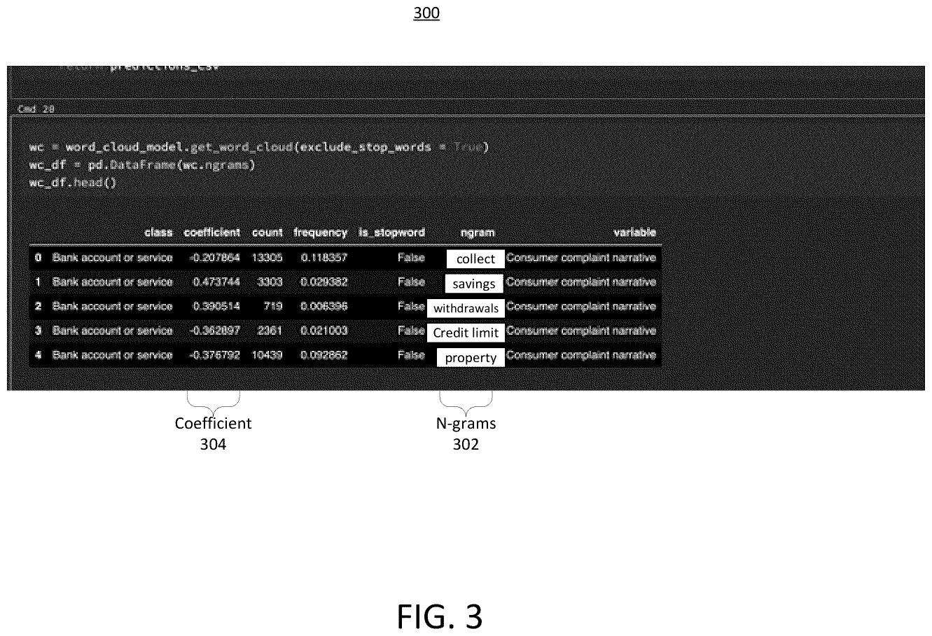

FIG. 3 is an example graphical user interface 300 depicting n-grams 302 extracted by the data processing system 102 from the text 202 in the data set. Each n-gram can have a coefficient 304 denoting polarity.

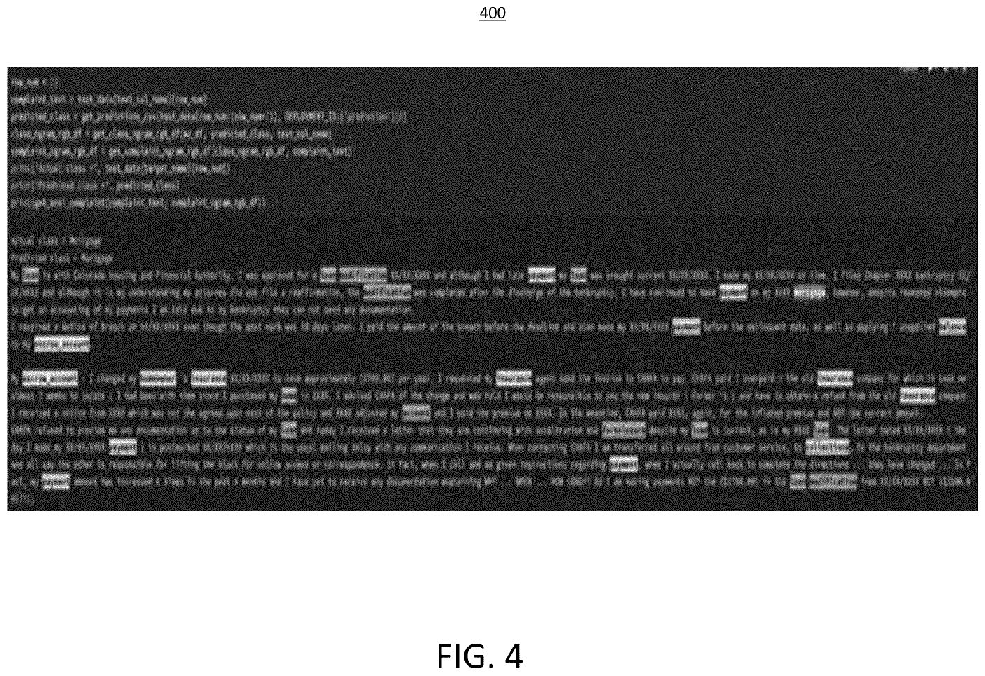

FIG. 4 is an example graphical user interface 400 of an example for displaying a prediction explanation with highlighted text and its color corresponding to the impact and polarity of the text, or n-gram, on a prediction. The n-gram can be highlighted with a color, such as red, to depict a positive impact. The n-gram can be highlighted with a color, such as blue, to depict a negative impact. The shade of the red or blue can indicate the degree or amount of the impact. The color can depict or indicate the polarity of the impact (e.g., negative or positive). A term can be highlighted in gray or without color if the n-gram is unknown or not used by the predictor.

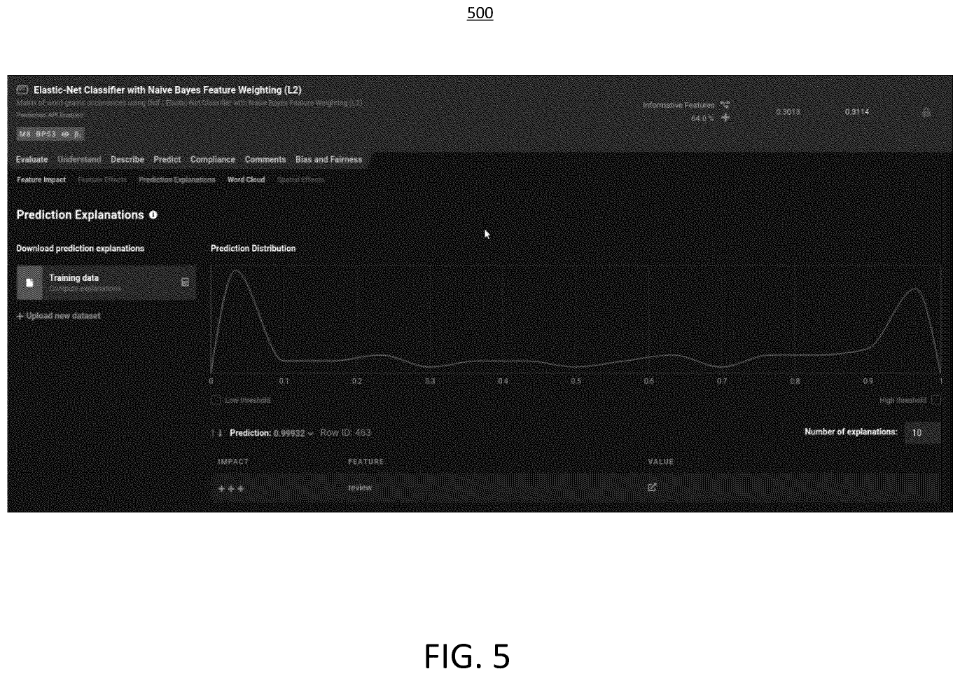

FIG. 5 depicts a graphical user interface (“GUI”) 500 depicting a prediction distribution. The graphical user interface 500 illustrates a color map where blue can signify negative impact, and red can signify a positive impact, for example. The GUI 500 can include a pop-up icon to depict a text explanations output.

FIG. 6 depicts a graphical user interface 600 with text predictions output. The GUI 600 can indicate a prediction output by the predictor 110 for a text data set. The GUI 600 can display at a least a portion 602 of the data set that includes text and was input into the data processing system 102. The GUI 600 can indicate a prediction 610 generated by the predictor 110. The GUI 600 can indicate the n-grams in the text 602 that impacted the prediction. The portion 602 can be the raw data set or raw text that was input into the data processing system 102. The text 602 may not be just features extracted by the feature generator 108. Rather, the data processing system 102 can output the raw text 602.

The data processing system 102 can highlight n-grams such as n-gram “great” 612 and n-gram “Powell” 616 in red to indicate that these n-grams had a positive impact 606 on the prediction 610. The data processing system 102 can highlight n-gram “Michael” 614 to indicate the n-gram had a negative impact 604 on the prediction 610. The GUI 600 can include indicate unknown n-grams by selecting the GUI element 608.

FIG. 7 depicts a graphical user interface 700 with text predictions output in which unknown n-grams are highlighted in gray, such n-gram “the” 702 and n-gram “of” 704.

For example, the system can determine that a second n-gram of the plurality of n-grams is not used to generate a feature for input into the model to make the first prediction. The system can select, based on a map, a second visual indication different from the visual indication for the second n-gram. The system can cause the user interface to present at least the portion of the first data set with the second visual indication applied to the second n-gram. For example, the impact of the first n-gram is one of negative or positive on the first prediction. For example, the system can apply the visual indication to the first n-gram with a color selected from a color map that highlights the first n-gram in the user interface.

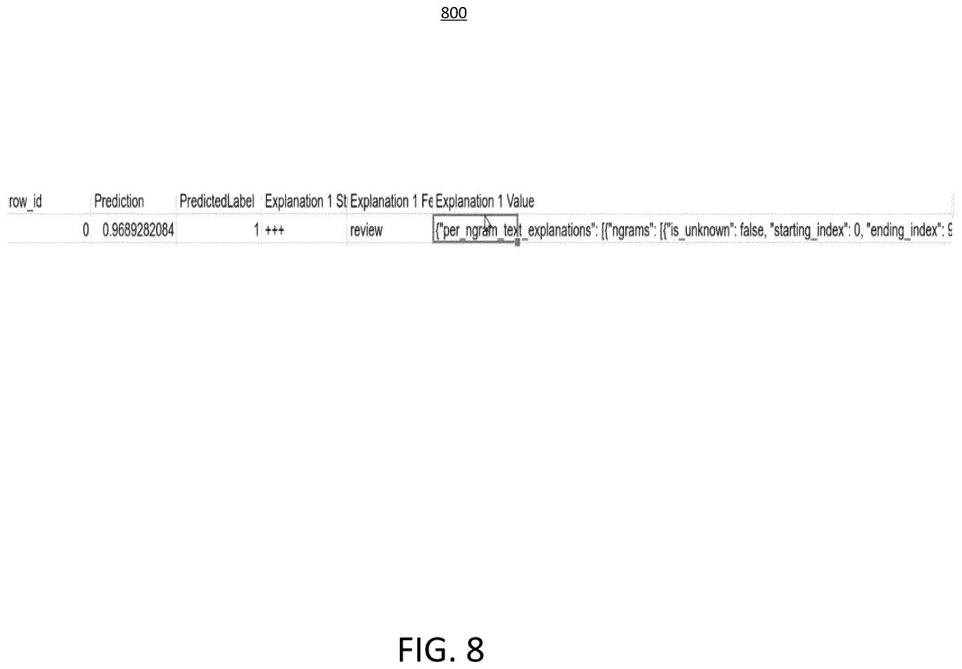

FIG. 8 depicts a downloadable output 800 of the text explanation which indicates the n-gram and an explanation value. For example, the downloadable output 800 can correspond to one or more quantitative metrics corresponding to an n-gram. For example, quantitative metrics can include an identifier (including a row identifier), a quantitative prediction, a label corresponding to the quantitative prediction, an explanation rank (e.g., +++ to indicate high impact or order), an explanation flag, (e.g., to review the explanation), and an explanation value (e.g., input or output corresponding to the n-gram and the prediction).

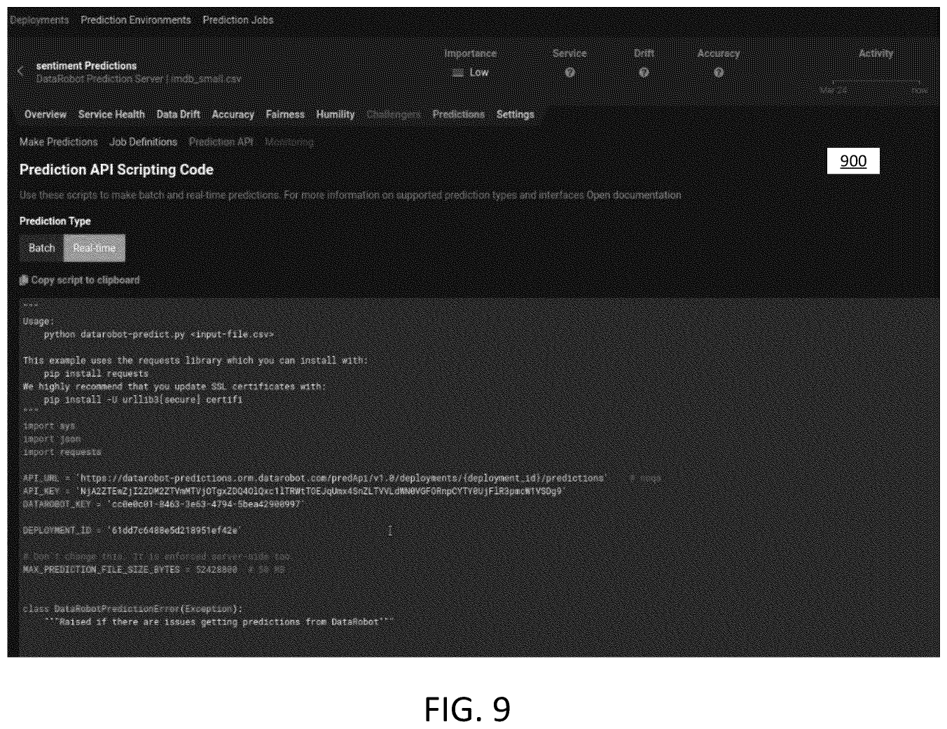

FIG. 9 depicts an example user interface 900 including code that can be used to generate a prediction application programming interface. This technical solution is not limited to the example code corresponding to the user interface 900.

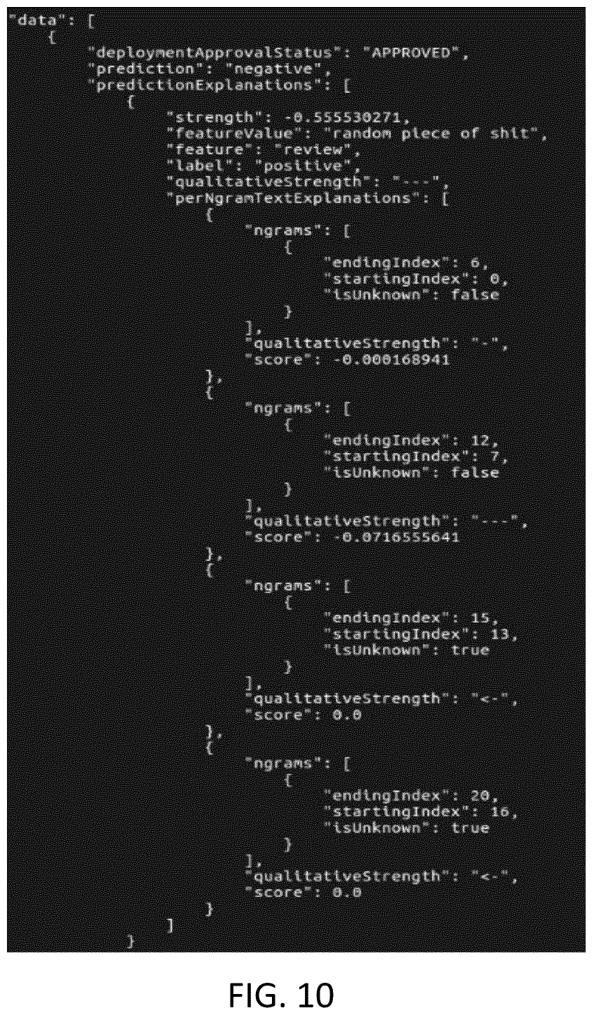

FIG. 10 depicts an example output of the data from the data processing system that includes the n-gram, the location of the n-gram in the text set (e.g., a starting an ending index for the n-gram), and an impact (e.g., positive, negative, score of impact, or unknown).

For example, the system can determine that a second n-gram of the plurality of n-grams is not used to generate a feature for input into the model to make the first prediction. The system can select, based on a map, a second visual indication different from the visual indication for the second n-gram. The system can cause the user interface to present at least the portion of the first data set with the second visual indication applied to the second n-gram. For example, the impact of the first n-gram is one of negative or positive on the first prediction. For example, the system can apply the visual indication to the first n-gram with a color selected from a color map that highlights the first n-gram in the user interface.

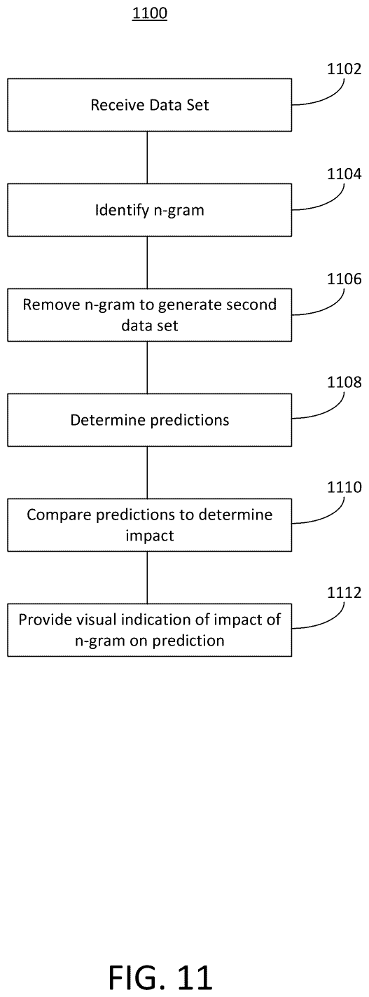

FIG. 11 is a block diagram of a method 1100 for machine learning model interpretations of text n-grams. The method 1100 can be performed by one or more component or system depicted in FIG. 1 or 12, including, for example, a data processing system. The method 1100 can include the data processing system receiving a data set at ACT 1102. At ACT 1104, the method 1100 can include the data processing system identifying n-grams in the data set. At ACT 1106, the method 1100 can include the data processing system removing n-grams iteratively to generate different data sets of feature sets that can be input into a model to generate predictions. At ACT 1108, the method 1100 can include the data processing system determining predictions using the different data sets with and without n-grams. At ACT 1110, the method 1100 can include comparing the predictions without n-grams with a baseline prediction that includes the data set. At ACT 1112, the method 1100 can include the data processing system providing a visual indication of the impact of the n-gram on the prediction and the polarity (e.g., negative or positive) of the impact.

An example method or function executed by the data processing system to provide text explanations as depicted in the GUIS 600 and 700 can include:

Data processing system 102 can choose a tokenizer 106 and identify n-gram positions of the original text including, but not limited to the applications noted below:
a. Pretrained Multilingual Byte Pair Encoding model trained on 275 languages used for languages without space as a word separator
   i. “japanese”,
   ii. “chinese”,
   iii. “thai”,
   iv. “lao”,
   v. “korean”,
   vi. “central khmer”,
   vii. “tibetan”,
   viii. “sundanese”,
   ix. “javanese”,
   x. “burmese”,
   xi. “vietnamese”,
   xii. “amharic”,
   xiii. “burmese”,
   xiv. “Dzongkha”
b. Data processing system 102 can use a Treebank Tokenizer for all other languages

Data processing system 102 can detect interactions between the n-grams, if no interactions, n-grams will be explained as is but if there is n-grams will be grouped together.

Data processing system 102 can loop through each ngrams identified by the tokenizer by order:
c. Mask out all context words surrounding the token by using “_” on the original text

### EXAMPLE

Original text=“My lovEly pAtent”

(to illustrate that nothing is changed from the original text the words in the original text have mixed upper and lower case)
Case 1: Original text has 3 ngrams identified by the tokenizer without interactions
The data processing system 102 can loop through the n-grams and generate:
“My_ _”
“_lovEly_”
“_ _ pAtent”
Case 2: Original text has 3 ngrams identified by the tokenizer with interactions between “lovEly pAtent”
“My_ _”
“_lovEly pAtent”
Case 3: Original text has 3 ngrams identified by the tokenizer with interactions between “My” and “pAtent”
“My_pAtent”
“_lovEly_”

Obtain attribution per n-gram or per ngram group by the following function: i) prediction of a sentence with masked out context; ii) prediction on a baseline with entirely masked out sentence. Where Where Baseline =“ [symbol] ”

For example:

attribution(“My _ _”) = prediction(“My _ _”) - prediction(“_ _ _”)
attribution(“_ lovEly pAtent”) = prediction(“_ lovEly pAtent”) - prediction(“_ _ _”)

The data processing system 102 can normalize the attribution scores per row by dividing the values with the sum of top 10 attributions per row. The data processing system 102 can convert normalized score to symbols using one or more rules or techniques.

FIG. 12 is a block diagram of an example of the data processing system 102. The data processing system 102 can include or be a computer, a network appliance, a mobile device, a server, a cloud computing system, or other electronic devices or systems. The data processing system 102 can include at least one processor 1200, at least one memory 1215, at least one storage device 1205, and at least one input/output device 1220. The processor 1200, the memory 1215, the storage device 1205, and the input/output device 1220 can be interconnected, for example, using at least one system bus 1210. The processor 1200 can process instructions for execution within the data processing system 102. The processor 1200 can include a single-threaded processor. The processor 1200 can include a multi-threaded processor. The processor 1200 can process instructions stored in the memory 1215 or on the storage device 1205.

The memory 1215 can store information within the data processing system 102. The memory 1215 can include a non-transitory computer-readable medium. The memory 1215 can include a volatile memory unit. The memory 1215 can include a non-volatile memory unit. The storage device 1205 can provide mass storage for the data processing system 102. The storage device 1205 can include a non-transitory computer-readable medium. The storage device 1205 can include a hard disk device, an optical disk device, a solid-date drive, a flash drive, or some other large capacity storage device. The storage device 1205 can store long-term data (e.g., database data, file system data, etc.). At least one input/output device 1202 can perform input/output operations for the data processing system 102. The input/output device 1220 can include one or more of a network interface devices, e.g., an Ethernet card, a serial communication device, e.g., an RS-232 port, and/or a wireless interface device, e.g., a Wi-Fi card (e.g., an 802.11 card), a 3G wireless modem, a 4G wireless modem, or a 5G wireless modem. In some implementations, the input/output device 1220 can include driver devices configured to receive input data and send output data to client devices 110, e.g., keyboard, printer and display devices, smartphones, laptops, tablets, desktop computers, printers, speakers, microphones, or other devices. For example, the memory 1215 can correspond to a non-transitory computer readable medium. For example, the non-transitory computer readable medium can include one or more instructions executable by a processor. The processor can apply the visual indication to the first n-gram, the visual indication can include a color selected from a color map that highlights the first n-gram in the user interface, where the impact of the first n-gram is one of negative or positive on the first prediction.

Although an example computing system has been described in FIG. 12, the subject matter including the operations described in this specification can be implemented in other types of digital electronic circuitry, or in computer software, firmware, or hardware, including the structures disclosed in this specification and their structural equivalents, or in combinations of one or more of them.

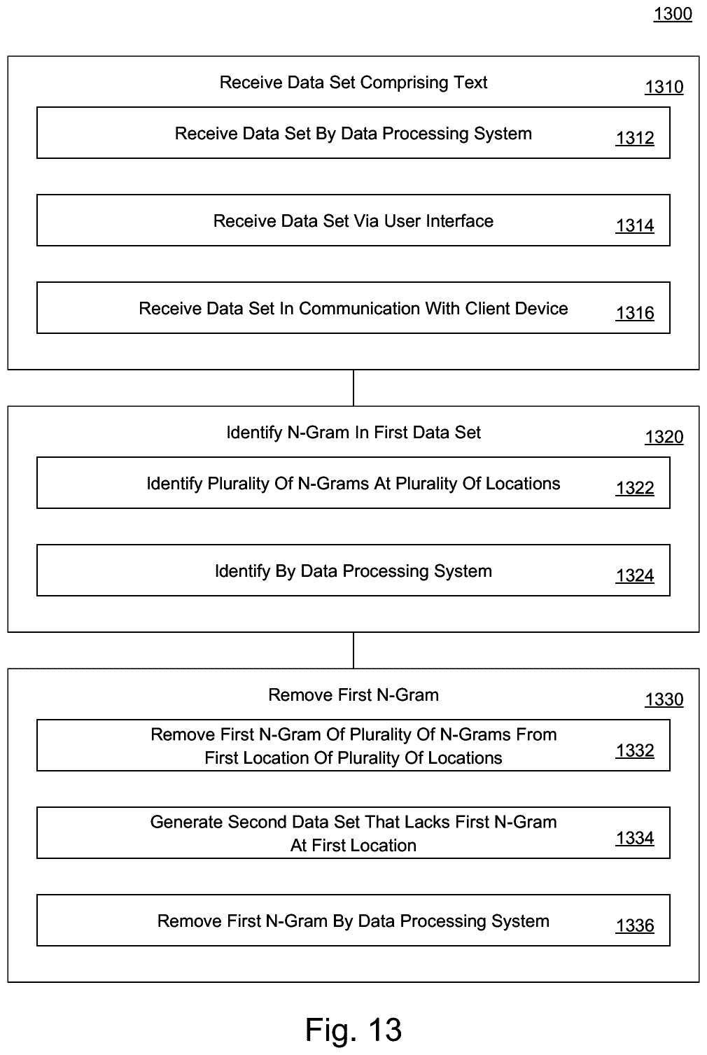

FIG. 13 depicts an example method in accordance with present implementations. At least one or more of the system 100, the user interfaces 200-1000, and the architecture 1200 can perform method 1300.

At 1310, the method 1300 can receive a data set comprising text. For example, the method can include receiving, by the data processing system, the first data set to include data in a plurality of modalities, where the plurality of modalities can include the text, a numerical value, and an image. At 1312, the method 1300 can receive the data set by a data processing system. At 1314, the method 1300 can receive the data set via a user interface . At 1316, the method 1300 can receive the data set in communication with a client device.

At 1320, the method 1300 can identify an n-gram in the first data set. For example, the method can include executing, by the data processing system, a tokenization technique to generate the plurality of n-grams, the tokenization technique can include at least one of a deep learning tokenizer, a treebank tokenizer, or linguistic rules. For example, the first n-gram comprises a plurality of contiguous words from the text. At 1322, the method 1300 can identify a plurality of n-grams at a plurality of locations. At 1324, the method 1300 can identify by a data processing system. For example, the method can include generating, by the data processing system, a feature for the first data set based at least in part on the first n-gram at the first location. The method can include inputting, by the data processing system, the feature into the model to generate the first prediction.

For example, the method can include applying, by the data processing system, the visual indication to the first n-gram, the visual indication can include a color selected from a color map that highlights the first n-gram in the user interface, where the impact of the first n-gram is one of negative or positive on the first prediction.

At 1330, the method 1300 can remove a first n-gram. At 1332, the method 1300 can remove a first n-gram of the plurality of n-grams from a first location of the plurality of locations. At 1334, the method 1300 can generate a second data set that lacks the first n-gram at the first location. At 1336, the method 1300 can remove the first n-gram by the data processing system.

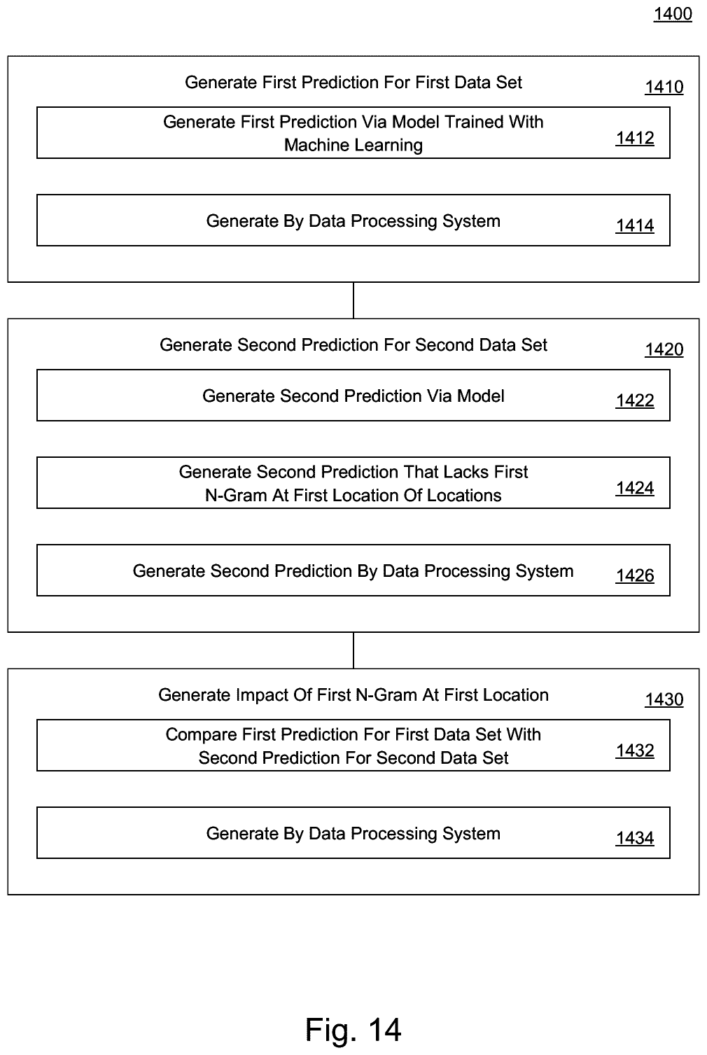

FIG. 14 depicts an example method in accordance with present implementations. At least one or more of the system 100, the user interfaces 200-1000, and the architecture 1200 can perform method 1400. At 1410, the method 1400 can generate a first prediction for the first data set. At 1412, the method 1400 can generate the first prediction via a model trained with machine learning. At 1414, the method 1400 can generate by the data processing system. At 1420, the method 1400 can generate a second prediction for a second data set . At 1422, the method 1400 can generate a second prediction via the model. At 1424, the method 1400 can generate a second prediction that lacks the first n-gram at a first location of the locations. At 1426, the method 1400 can generate a second prediction by the data processing system. At 1430, the method 1400 can generate an impact of the first n-gram at the first location. At 1432, the method 1400 can compare a first prediction for the first data set with a second prediction for the second data set. At 1434, the method 1400 can generate by the data processing system.

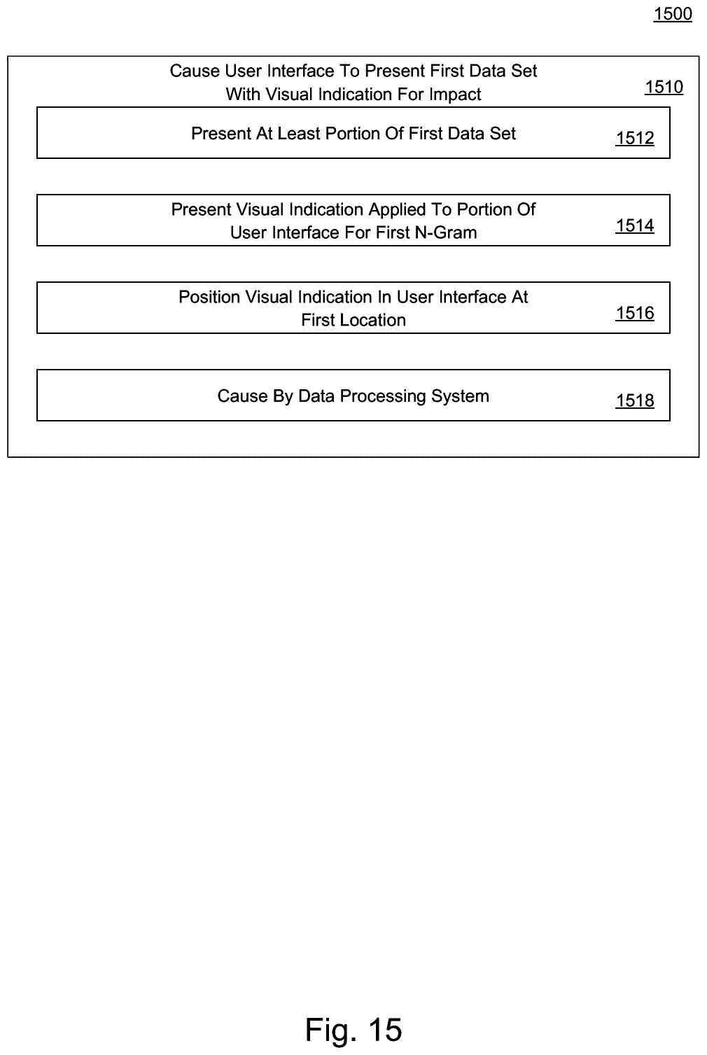

FIG. 15 depicts an example method in accordance with present implementations. At least one or more of the system 100, the user interfaces 200-1000, and the architecture 1200 can perform method 1500. At 1510, the method 1500 can cause a user interface to present the first data set with a visual indication for the impact. For example, the method can include applying, by the data processing system, the visual indication to the first n-gram, where the visual indication can include a color selected from a color map that highlights the first n-gram in the user interface, where the impact of the first n-gram is one of negative or positive on the first prediction. At 1512, the method 1500 can present at least a portion of the first data set. At 1514, the method 1500 can present a visual indication applied to a portion of the user interface for the first n-gram. At 1516, the method 1500 can position the visual indication in the user interface at the first location. At 1518, the method 1500 can cause by the data processing system.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

“Data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature's data type is categorical if the set of values that can be assigned to the feature is finite.

“Time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

“Image data” may refer to a sequence of digital images (e.g., video), a set of digital images, a single digital image, and/or one or more portions of any of the foregoing. A digital image may include an organized set of picture elements (“pixels”). Digital images may be stored in computer-readable file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

“Non-image data” may refer to any type of data other than image data, including but not limited to structured textual data, unstructured textual data, categorical data, and/or numerical data. “Natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a machine learning algorithm and a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

As used herein, “automated machine learning platform” (e.g., “automated ML platform” or “AutoML platform”) may refer to a computer system or network of computer systems, including the user interface, processor(s), memory device(s), components, modules, etc. that provide access to or implement automated machine learning techniques.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, the plural terms can be translated to the singular and/or from the singular to the plural as is appropriate to the context and/or application. The various singular/plural permutations may be expressly set forth herein for sake of clarity.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

General terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

If a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors and memory to:
identify a plurality of n-grams at a plurality of locations in a first data set comprising text;
generate, via a model trained with machine learning, a first prediction for the first data set;
generate, via the model, a second prediction for a second data set, wherein the second data set lacks a first n-gram at a first location of the plurality of locations;
generate, by comparing a first prediction for the first data set with a second prediction for the second data set, an impact of the first n-gram at the first location; and
cause a user interface to present at least a portion of the first data set with a visual indication corresponding to the impact, the visual indication applied to a portion of the user interface corresponding to the first n-gram and positioned in the user interface at the first location.

2. The system of claim 1, comprising:
the data processing system to receive the first data set comprising data in a plurality of modalities.

3. The system of claim 1, comprising:
the data processing system to receive the first data set comprising the text, a numerical value, and an image.

4. The system of claim 1, comprising:
the data processing system to execute a tokenization technique to generate the plurality of n-grams.

5. The system of claim 4, wherein the tokenization technique comprises at least one of a deep learning tokenizer, a treebank tokenizer, or linguistic rules.

6. The system of claim 1, wherein the first n-gram comprises a word from the text.

7. The system of claim 1, wherein the first n-gram comprises a plurality of contiguous words from the text.

8. The system of claim 1, comprising the data processing system to:
generate a feature for the first data set based at least in part on the first n-gram at the first location; and
input the feature into the model to generate the first prediction.

9. The system of claim 1, comprising the data processing system to:
determine that a second n-gram of the plurality of n-grams is not used to generate a feature for input into the model to make the first prediction;
select, based on a map, a second visual indication different from the visual indication for the second n-gram; and
cause the user interface to present at least the portion of the first data set with the second visual indication applied to the second n-gram.

10. The system of claim 1, wherein the impact of the first n-gram is one of negative or positive on the first prediction.

11. The system of claim 1, comprising:
the data processing system to apply the visual indication to the first n-gram comprising a color selected from a color map that highlights the first n-gram in the user interface.

12. A method, comprising:
receiving, by a data processing system, via a user interface and in communication with a client device, a data set comprising text;
identifying, by a data processing system comprising one or more processors and memory, a plurality of n-grams at a plurality of locations in a first data set;
removing, by the data processing system, a first n-gram of the plurality of n-grams from a first location of the plurality of locations to generate a second data set that lacks the first n-gram at the first location;
generating, by the data processing system, via a model trained with machine learning, a first prediction for the first data set;
generating, by the data processing system via the model, a second prediction for a second data set, wherein the second data set lacks a first n-gram at a first location of the plurality of locations;
generating, by the data processing system comparing a first prediction for the first data set with a second prediction for the second data set, an impact of the first n-gram at the first location; and
causing by the data processing system, a user interface to present at least a portion of the first data set with a visual indication corresponding to the impact, the visual indication applied to a portion of the user interface corresponding to the first n-gram and positioned in the user interface at the first location.

13. The method of claim 12, comprising:
receiving, by the data processing system, the first data set comprising data in a plurality of modalities, the plurality of modalities comprising the text, a numerical value, and an image.

14. The method of claim 12, comprising:
executing, by the data processing system, a tokenization technique to generate the plurality of n-grams, the tokenization technique comprising at least one of a deep learning tokenizer, a treebank tokenizer, or linguistic rules.

15. The method of claim 12, wherein the first n-gram comprises a plurality of contiguous words from the text.

16. The method of claim 12, comprising:
generating, by the data processing system, a feature for the first data set based at least in part on the first n-gram at the first location; and
inputting, by the data processing system, the feature into the model to generate the first prediction.

17. The method of claim 12, comprising:
determining, by the data processing system, that a second n-gram of the plurality of n-grams is not used to generate a feature for input into the model to make the first prediction;
selecting, by the data processing system based on a map, a second visual indication different from the visual indication for the second n-gram; and
causing, by the data processing system, the user interface to present at least the portion of the first data set with the second visual indication applied to the second n-gram.

18. The method of claim 12, comprising:
applying, by the data processing system, the visual indication to the first n-gram, the visual indication comprising a color selected from a color map that highlights the first n-gram in the user interface, wherein the impact of the first n-gram is one of negative or positive on the first prediction.

19. A non-transitory computer readable medium storing instructions that, when executed by one or more processors, cause the one or more processors to:
identify a plurality of n-grams at a plurality of locations in a first data set comprising text;
generate, via a model trained with machine learning, a first prediction for the first data set;
generate, via the model, a second prediction for the second data set, wherein the second data set lacks a first n-gram at a first location of the plurality of locations;
generate, by a comparison of a first prediction for the first data set with a second prediction for the second data set, an impact of the first n-gram at the first location; and
cause a user interface to present at least a portion of the first data set with a visual indication corresponding to the impact, the visual indication applied to the first n-gram and positioned in the user interface at the first location.

20. The non-transitory computer readable medium of claim 19, the computer readable medium further includes one or more instructions executable by the processor to:
apply the visual indication to the first n-gram, the visual indication comprising a color selected from a color map that highlights the first n-gram in the user interface, wherein the impact of the first n-gram is one of negative or positive on the first prediction.
